(19) United States
(12) Patent Application Publication
(10) Pub. No.: US 2026/0268324 A1
(43) Pub. Date: Sep. 10, 2026

(54) Method, System, and Computer Program Product for Processing a Settlement Request

(71) Applicant: Visa International Service Association, San Francisco, CA (US)

(72) Inventors: Luis Michelangeli, Doral, FL (US); Silvia Elena Garcia, Panama City (PA); Lee O. Araujo Martinez, Doral, FL (US); Carlos Javier Lobalzo Esposito, Buenos Aires (AR); Ana Montero, Miami, FL (US); Stephania Quintero, Miami, FL (US); Rodrigo Barros de Paula, Miami Shores, FL (US)

(21) Appl. No.: 19/556,034

(22) Filed: Mar. 4, 2026

Related U.S. Application Data
(60) Provisional application No. 63/766,617, filed on Mar. 4, 2025.

(51) Int. Cl. G06Q 20/40

(52) U.S. Cl. CPC G06Q 20/401

(57) ABSTRACT

Methods, systems, and computer program products are provided for processing a settlement request. An example method includes: receiving a settlement request associated with a pre-authorized transaction between a first and second system, the pre-authorized transaction associated with a settlement amount to be transferred from a first account to a second account, the pre-authorized transaction initiated by the second system without a credential issued to the second system by an issuer system, the pre-authorized transaction authorized by the first system prior to the transaction service provider processor receiving the settlement request; in response to receiving the settlement request, identifying the first and second accounts based on a first identifier and a second identifier contained in the settlement request; and causing transfer of the settlement amount from the first account to the second account.

### CROSS REFERENCE TO RELATED APPLICATION

The present application claims the benefit of United States Patent Provisional Application No. 63/766,617, filed Mar. 4, 2025, the entire disclosure of which is hereby incorporated by reference in its entirety.

### BACKGROUND

### Technical Field

This disclosure relates generally to processing settlement requests and, in non-limiting embodiments or aspects, to methods, systems, and computer program products for processing settlement requests.

### 2. Technical Considerations

Account clearing house (ACH) payments lack scalability, speed, and traceability, such that they are unsuitable for rapid and transparent business-to-business (B2B) transactions. Credential-based payment transactions also have significant drawbacks for B2B transactions, such as the need for an authorization infrastructure and the issuance of the credentials.

### SUMMARY

Accordingly, provided are improved methods, systems, and computer program products for processing settlement requests.

According to non-limiting embodiments or aspects, provided is a computer-implemented method including: receiving, with a transaction service provider processor, a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the transaction service provider processor receiving the settlement request; in response to receiving the settlement request, identifying, with the transaction service provider processor, the account of the first system and the account of the second system based on a first identifier and a second identifier contained in the settlement request; and causing, with the transaction service provider processor, transfer of the settlement amount from the account of the first system to the account of the second system.

In some non-limiting embodiments or aspects, the computer-implemented method may further include: generating, with the second system, an authorization request associated with the pre-authorized transaction; transmitting, with the second system, the authorization request to the first system; in response to receiving the authorization request, authorizing, with the first system, the pre-authorized transaction; and in response to authorizing the authorization request, generating, with the first system, the settlement request.

In some non-limiting embodiments or aspects, the settlement request may be processed by the transaction service provider processor without interaction with an issuer system.

In some non-limiting embodiments or aspects, the account of the first system may be associated with a first bank system, and the account of the second system may be associated with a second bank system different from the first bank system.

In some non-limiting embodiments or aspects, the first bank system may be based in a first country and the second bank system may be based in a second country different from the first country.

In some non-limiting embodiments or aspects, the settlement request may contain the first identifier, the second identifier, and the settlement amount.

In some non-limiting embodiments or aspects, the first identifier may be a unique identifier identifying the first system, and the second identifier may be a unique identifier identifying the second system.

In some non-limiting embodiments or aspects, the settlement request may be settled using the same settlement infrastructure as credential-based electronic payment transactions.

In some non-limiting embodiments or aspects, the first system may not directly instruct a first bank system associated with the account of the first system to transfer the settlement amount to the account of the second system.

According to some non-limiting embodiments or aspects, provided is a system, including: at least one processor configured to: receive a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the at least one processor receiving the settlement request; in response to receiving the settlement request, identify the account of the first system and the account of the second system based on a first identifier and a second identifier contained in the settlement request; and cause transfer of the settlement amount from the account of the first system to the account of the second system.

In some non-limiting embodiments or aspects, the system further includes: the first system including one or more first processors and the second system including one or more second processors, wherein the one or more second processors are configured to: generate an authorization request associated with the pre-authorized transaction; and transmit the authorization request to the first system, wherein the one or more first processors are configured to: in response to receiving the authorization request, authorize the pre-authorized transaction; and in response to authorizing the authorization request, generate the settlement request.

In some non-limiting embodiments or aspects, the settlement request is processed by the at least one processor without interaction with an issuer system.

In some non-limiting embodiments or aspects, the account of the first system is associated with a first bank system, and the account of the second system is associated with a second bank system different from the first bank system.

In some non-limiting embodiments or aspects, the first bank system is based in a first country and the second bank system is based in a second country different from the first country.

In some non-limiting embodiments or aspects, the settlement request contains the first identifier, the second identifier, and the settlement amount.

In some non-limiting embodiments or aspects, the first identifier is a unique identifier identifying the first system, and the second identifier is a unique identifier identifying the second system.

In some non-limiting embodiments or aspects, the settlement request is settled using the same settlement infrastructure as credential-based electronic payment transactions.

In some non-limiting embodiments or aspects, the first system does not directly instruct a first bank system associated with the account of the first system to transfer the settlement amount to the account of the second system.

According to some non-limiting embodiments or aspects, provided is a computer program product including at least one non-transitory computer-readable medium including program instructions that, when executed by at least one processor, cause the at least one processor to: receive a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the at least one processor receiving the settlement request; in response to receiving the settlement request, identify the account of the first system and the account of the second system based on a first identifier and a second identifier contained in the settlement request; and cause transfer of the settlement amount from the account of the first system to the account of the second system.

In some non-limiting embodiments or aspect, the program instructions, when executed by the at least one processor, cause the at least one processor to process the settlement request without interaction with an issuer system.

Further non-limiting embodiments or aspects are set forth in the following numbered clauses:

Clause 1: A computer-implemented method, comprising: receiving, with a transaction service provider processor, a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the transaction service provider processor receiving the settlement request; in response to receiving the settlement request, identifying, with the transaction service provider processor, the account of the first system and the account of the second system based on a first identifier and a second identifier contained in the settlement request; and causing, with the transaction service provider processor, transfer of the settlement amount from the account of the first system to the account of the second system.

Clause 2: The computer-implemented method of clause 1, further comprising: generating, with the second system, an authorization request associated with the pre-authorized transaction; transmitting, with the second system, the authorization request to the first system; in response to receiving the authorization request, authorizing, with the first system, the pre-authorized transaction; and in response to authorizing the authorization request, generating, with the first system, the settlement request.

Clause 3: The computer-implemented method of clause 1 or 2, wherein the settlement request is processed by the transaction service provider processor without interaction with an issuer system.

Clause 4: The computer-implemented method of any of clauses 1-3, wherein the account of the first system is associated with a first bank system, and the account of the second system is associated with a second bank system different from the first bank system.

Clause 5: The computer-implemented method of any of clauses 1-4, wherein the first bank system is based in a first country and the second bank system is based in a second country different from the first country.

Clause 6: The computer-implemented method of any of clauses 1-5, wherein the settlement request contains the first identifier, the second identifier, and the settlement amount.

Clause 7: The computer-implemented method of any of clauses 1-6, wherein the first identifier is a unique identifier identifying the first system, and the second identifier is a unique identifier identifying the second system.

Clause 8: The computer-implemented method of any of clauses 1-7, wherein the settlement request is settled using the same settlement infrastructure as credential-based electronic payment transactions.

Clause 9: The computer-implemented method of any of clauses 1-8, wherein the first system does not directly instruct a first bank system associated with the account of the first system to transfer the settlement amount to the account of the second system.

Clause 10: A system, comprising: at least one processor configured to: receive a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the transaction service provider processor receiving the settlement request; in response to receiving the settlement request, identify the account of the first system and the account of the second system based on a first identifier and a second identifier contained in the settlement request; and cause transfer of the settlement amount from the account of the first system to the account of the second system.

Clause 11: The system of clause 10, further comprising: the first system including one or more first processors; and the second system including one or more second processors, wherein the one or more second processors are configured to: generate an authorization request associated with the pre-authorized transaction; and transmit the authorization request to the first system, wherein the one or more first processors are configured to: in response to receiving the authorization request, authorizing, with the first system, the pre-authorized transaction; and in response to authorizing the authorization request, generating, with the first system, the settlement request.

Clause 12: The system of clause 10 or 11, wherein the settlement request is processed by the at least one processor without interaction with an issuer system.

Clause 13: The system of any of clauses 10-12, wherein the account of the first system is associated with a first bank system, and the account of the second system is associated with a second bank system different from the first bank system.

Clause 14: The system of any of clauses 10-13, wherein the first bank system is based in a first country and the second bank system is based in a second country different from the first country.

Clause 15: The system of any of clauses 10-14, wherein the settlement request contains the first identifier, the second identifier, and the settlement amount.

Clause 16: The system of any of clauses 10-15, wherein the first identifier is a unique identifier identifying the first system, and the second identifier is a unique identifier identifying the second system.

Clause 17: The system of any of clauses 10-16, wherein the settlement request is settled using the same settlement infrastructure as credential-based electronic payment transactions.

Clause 18: The system of any of clauses 10-17, wherein the first system does not directly instruct a first bank system associated with the account of the first system to transfer the settlement amount to the account of the second system.

Clause 19: A computer program product comprising at least one non-transitory computer-readable medium including program instructions that, when executed by at least one processor, cause the at least one processor to: receive a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the transaction service provider processor receiving the settlement request; in response to receiving the settlement request, identify the account of the first system and the account of the second system based on a first identifier and a second identifier contained in the settlement request; and cause transfer of the settlement amount from the account of the first system to the account of the second system.

Clause 20: The computer program product of clause 19, wherein the program instructions, when executed by the at least one processor, cause the at least one processor to process the settlement request without interaction with an issuer system.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for processing settlement requests, according to some non-limiting embodiments or aspects;

FIG. 2 is a flow diagram of a method for processing settlement requests, according to some non-limiting embodiments or aspects;

FIG. 3 is a schematic diagram of an example environment in which methods, systems, and/or computer program products, described herein, may be implemented according to some non-limiting embodiments or aspects;

FIG. 4 is a schematic diagram of example components of one or more devices of FIGS. 1 and 3, according to some non-limiting embodiments or aspects; and

FIG. 5 is a signal flow diagram of an implementation of methods, systems, and/or computer program products, described herein, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “payment network rails” or “payment network rails environment” may refer to the existing transaction-clearing and settlement infrastructure operated by a transaction service provider (e.g., a payment network) that is used to route transaction records/messages, perform clearing-related processing, and coordinate interbank settlement (funds movement) among participating financial institutions. For example, as used in the specification and the claims “payment network rails” may refer to the network’s endpoints/interfaces for submitting transaction records (e.g., records files/batch files), validation/format-edit and clearing functions, settlement position calculation, and settlement execution/coordination through participating banks, and/or generation of settlement confirmations/reports.

Non-limiting embodiments or aspects of the disclosed subject matter are directed to methods, systems, and computer program products for processing settlement requests. The process of the present disclosure improves payment transfer systems by overcoming lack of scalability, speed, and traceability of ACH-based payments and overcoming the requirements for an authorization infrastructure and the issuance of the credentials from credential-based payment transactions.

Non-limiting embodiments or aspects include a pre-authorization of the transaction by a payor system in response to receiving an authorization request from a payee system. The transaction is initiated without a payment credential (e.g., a payment device) being issued to the payee and/or the payor by an issuer system. The efficiency of the transaction is enhanced by the removal of an authorization infrastructure that requires the issuer system to issue credentials and subsequently authorize transactions as they are initiated. Instead, the payee system submits an authorization request to the payor system, and, in response, the payor system authorizes the transaction.

Further non-limiting embodiments or aspects reduce the processing resources expended by the payor system, compared to ACH-based transactions. In ACH-based transactions, the payor system is required to transmit instructions to its payor bank in order to effect the transfer of funds. However, the payor system lacks suitability for such instructions, which introduces transfer errors and poor transparency into ACH-based transactions. In contrast, the process of the present disclosure involves the payor system transmitting a settlement request to the transaction service provider system, which is configured to more efficiently and more transparently execute transfer requests without numerous errors. Thus, the unconventional flow, described herein, reduces the burden on the payor systems and improves the overall efficiency and reliability of the transfer system.

For the purpose of illustration, in the following description, while the presently disclosed subject matter is described with respect to methods, systems, and computer program products for processing settlement requests, one skilled in the art will recognize that the disclosed subject matter is not limited to the non-limiting embodiments or aspects disclosed herein. For example, methods, systems, and computer program products, described herein, may be used in a wide variety of settings, such as to effect settlement requests for payment transactions.

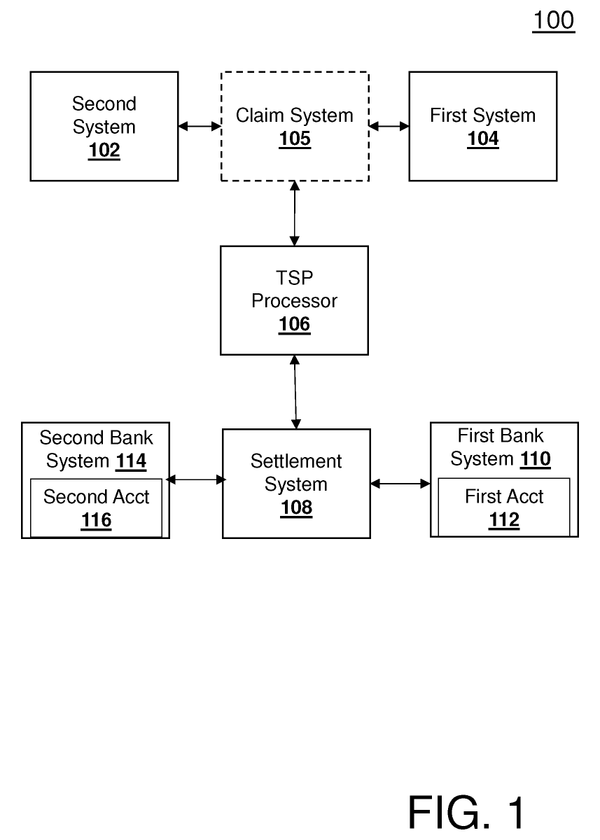

Referring now to FIG. 1, shown is system 100 for processing settlement requests, according to some non-limiting embodiments or aspects. System 100 may include second system 102, first system b, claim system 105, transaction service provider (TSP) processor 106, settlement system 108, first bank system 110 having first account 112, and/or second bank system 114 having second account 116. System 100 may enable processing of settlement requests in business-to-business (B2B) transactions and/or payor-payee transactions without issuing credentials to a payee party by an issuer system. System 100 may enable processing of a settlement request over a TSP network without issuance of credentials by an issuer system.

First system 104 may include at least one computing device as described herein. For example, first system 104 may include a computer (e.g., portable computer, non-mobile computer, and/or the like), a server (e.g., a single server), a group of servers, and/or other like devices of a user. In some non-limiting embodiments or aspects, first system 104 may include at least one processor (e.g., a multi-core processor), such as a graphics processing unit (GPU), a central processing unit (CPU), an accelerated processing unit (APU), a microprocessor, and/or the like. In some non-limiting embodiments or aspects, first system 104 may include memory, one or more storage components, one or more input components, one or more output components, and/or one or more communication interfaces, as described herein. First system 104 may be associated with a payor engaging in B2B and/or payor-payee transfer request. First system bmay comprise a payor system authorizing and/or transferring a payment amount (e.g., a settlement amount) to the payee system.

Second system 102 may include at least one computing device, as described herein. For example, second system 102 may include a computer (e.g., portable computer, non-mobile computer, and/or the like), a server (e.g., a single server), a group of servers, and/or other like devices of a user. In some non-limiting embodiments or aspects, second system 102 may include at least one processor (e.g., a multi-core processor), such as a GPU, a CPU, an APU, a microprocessor, and/or the like. In some non-limiting embodiments or aspects, second system 102 may include memory, one or more storage components, one or more input components, one or more output components, and/or one or more communication interfaces, as described herein. Second system 102 may be associated with a payee engaging in B2B and/or payor-payee transfer request. Second system 102 may comprise a payee system requesting a payment amount from the payor system.

In some non-limiting embodiments or aspects, first system 104 and second system 102 may be associated with a business, such that the transaction is a B2B transaction, although peer-to-peer (P2P) transactions are also within the scope of the present disclosure. First system 104 may comprise a data orchestrator configured to make frequent payments (as a payor) to one or more second system 102. For example, first system 104 may comprise an insurance provider configured to make frequent payments to one or more second systems 102 comprising healthcare providers (e.g., doctors, hospitals, pharmacies, and the like). For example, first system 104 may comprise a logistics system configured to make frequent payments to one or more second systems 102 comprising carriers making deliveries to clients.

System 100 may optionally include claim system 105 to facilitate communications between second system 102 and first system 104, such as authorization requests and/or authorization responses therebetween. Claim system 105 may transmit settlement requests from first system 104 to TSP processor 106. Claim system 105 may include at least one computing device, as described herein. For example, claim system 105 may include a computer (e.g., portable computer, non-mobile computer, and/or the like), a server (e.g., a single server), a group of servers, and/or other like devices of a user. In some non-limiting embodiments or aspects, claim system 105 includes at least one processor (e.g., a multi-core processor), such as a GPU, a CPU, an APU, a microprocessor, and/or the like. In some non-limiting embodiments or aspects, claim system 105 may include memory, one or more storage components, one or more input components, one or more output components, and/or one or more communication interfaces, as described herein.

TSP processor 106 may include at least one computing device, as described herein. For example, TSP processor 106 may include a computer (e.g., portable computer, non-mobile computer, and/or the like), a server (e.g., a single server), a group of servers, and/or other like devices of a user. In some non-limiting embodiments or aspects, TSP processor 106 may include at least one processor (e.g., a multi-core processor) such as a GPU, a CPU, an APU, a microprocessor, and/or the like. In some non-limiting embodiments or aspects, TSP processor 106 may include memory, one or more storage components, one or more input components, one or more output components, and/or one or more communication interfaces, as described herein. TSP processor 106 may process credential-based electronic payment transactions involving users, merchant systems, acquirer systems, and/or issuer systems, as is known in the art. A credential-based transaction is a transaction initiated by a user using a payment credential issued to the user by an issuer system. The payment credential may comprise a payment device, such as a credit or debit card. However, TSP processor 106 may make available its settlement infrastructure used for settling credential-based transactions to settle transactions initiated, as described herein (e.g., transactions initiated and processed without credentials issued by an issuer system).

Settlement system 108 may include at least one computing device, as described herein. For example, settlement system 108 may include a computer (e.g., portable computer, non-mobile computer, and/or the like), a server (e.g., a single server), a group of servers, and/or other like devices of a user. In some non-limiting embodiments or aspects, settlement system 108 may include at least one processor (e.g., a multi-core processor) such as a GPU, a CPU, an APU, a microprocessor, and/or the like. In some non-limiting embodiments or aspects, settlement system 108 may include memory, one or more storage components, one or more input components, one or more output components, and/or one or more communication interfaces, as described herein. Settlement system 108 may receive instructions from TSP processor 106 to settle a settlement request between second system 102 and first system 104. Settlement system 108 may cause transfer of a settlement amount from first bank system 110 having first account 112 of first system 104 to second bank system 114 having second account 116 of second system 102.

First bank system 110 may include at least one computing device, as described herein. For example, first bank system 110 may include a computer (e.g., portable computer, non-mobile computer, and/or the like), a server (e.g., a single server), a group of servers, and/or other like devices of a user. In some non-limiting embodiments or aspects, first bank system 110 may include at least one processor (e.g., a multi-core processor) such as a GPU, a CPU, an APU, a microprocessor, and/or the like. In some non-limiting embodiments or aspects, first bank system 110 may include memory, one or more storage components, one or more input components, one or more output components, and/or one or more communication interfaces, as described herein. First bank system 110 may be a system of a first bank, which may be the bank with which first system 104 banks. The first bank may issue first account 112 to first system 104, which may be a payment account from which and to which first system 104 may transmit and receive funds (e.g., to settle payment transactions).

Second bank system 114 may include at least one computing device, as described herein. For example, second bank system 114 may include a computer (e.g., portable computer, non-mobile computer, and/or the like), a server (e.g., a single server), a group of servers, and/or other like devices of a user. In some non-limiting embodiments or aspects, second bank system 114 may include at least one processor (e.g., a multi-core processor) such as a GPU, a CPU, an APU, a microprocessor, and/or the like. In some non-limiting embodiments or aspects, second bank system 114 may include memory, one or more storage components, one or more input components, one or more output components, and/or one or more communication interfaces, as described herein. Second bank system 114 may be a system of a second bank, which may be the bank with which second system 102 banks. The second bank may issue second account 116 to second system 102, which may be a payment account from which and to which second system 102 may transmit and receive funds (e.g., to settle payment transactions).

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

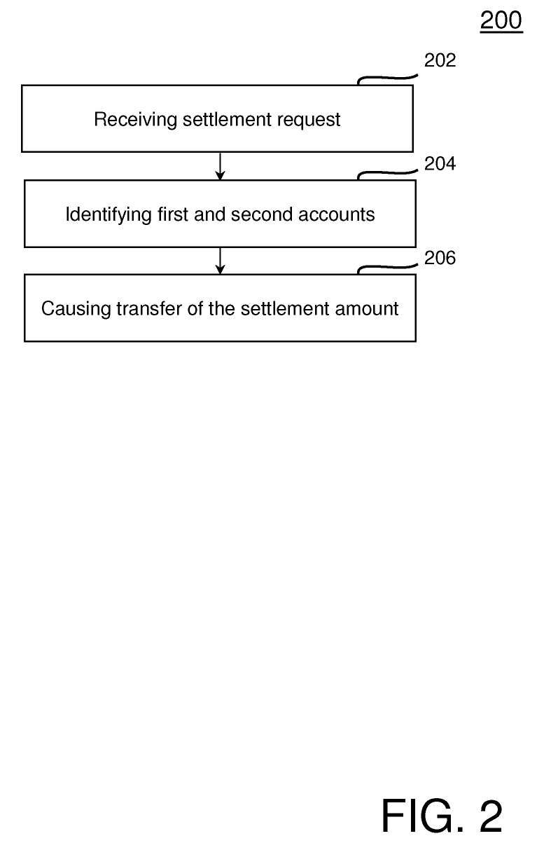

Referring now to FIG. 2, shown is a flow diagram for a method for processing settlement requests, according to some non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2, at step 202, process 200 may include: receiving, with a transaction service provider processor, a settlement request associated with a pre-authorized transaction between a first system and a second system. For example, TSP processor 106 may receive the settlement request from first system 104. The pre-authorized transaction may be associated with a settlement amount to be transferred from an account of the first system (first account 112) to an account of the second system (second account 116). The pre-authorized transaction may be initiated by second system 102 without a credential issued to second system 102 by an issuer system. The pre-authorized transaction may be authorized by first system 104 prior to TSP processor 106 receiving the settlement request.

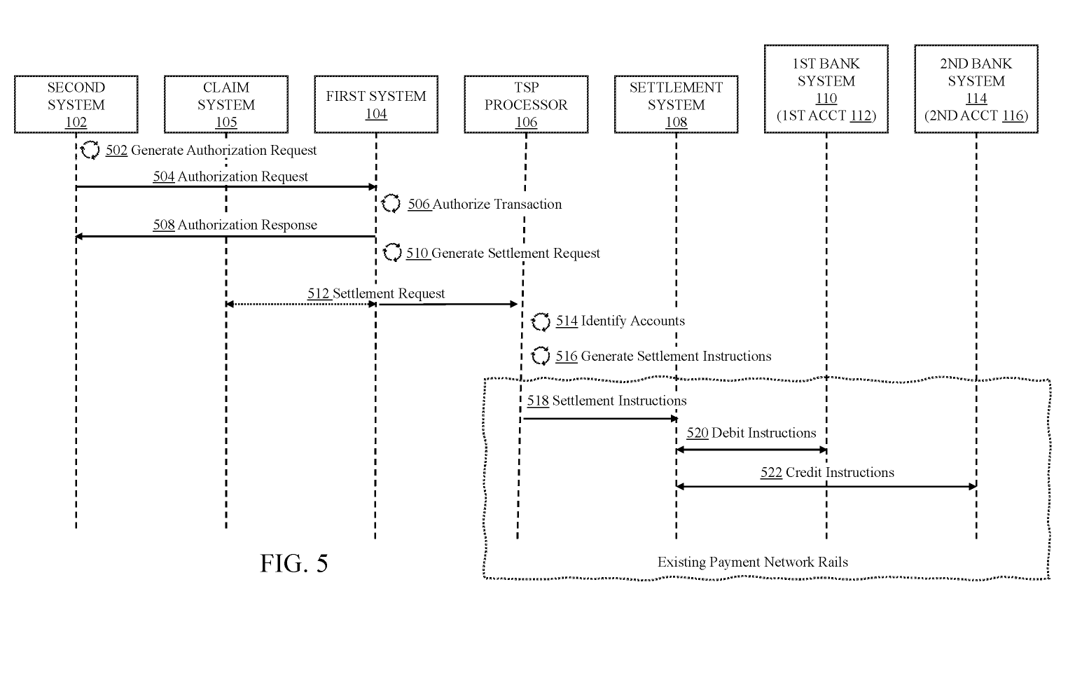

In some non-limiting embodiments or aspects, process 200 may further include (before TSP processor 106 receives the settlement request): generating, with second system 102, an authorization request associated with the pre-authorized transaction. For example and referring also to reference number 502 of FIG. 5, before transmitting the authorization request to first system 104 (and before TSP processor 106 receives the settlement request), second system 102 may generate the authorization request associated with the pre-authorized transaction. In some non-limiting embodiments or aspects, second system 102 generates the authorization request as a structured electronic message stored in memory (e.g., memory 406), generates via execution of instructions by a processor (e.g., processor 404), and configures to enable first system 104 to authorize a credential-less electronic payment transaction that is later settled over settlement infrastructure of the transaction service provider (e.g., via TSP processor 106 and settlement system 108) without relying on an issuer-issued credential.

In some non-limiting embodiments or aspects, second system 102 automatically generates the authorization request in response to a trigger event indicating that a payment obligation is ready to be submitted for pre-authorization by first system 104. For example, the trigger event may include generation of an invoice, completion of a goods/services event, completion of a claim event, generation of a payables instruction, and/or other events indicating that a payment obligation is ready for authorization by first system 104. Second system 102 may assemble the authorization request by retrieving transaction data from one or more storage components (e.g., storage component 408) and populating corresponding fields of the authorization request in memory (e.g., memory 406) for transmission via a communication interface (e.g., communication interface 414).

In some non-limiting embodiments or aspects, the authorization request includes a set of fields that enables first system 104 to evaluate and authorize the pre-authorized transaction without requiring a credential issued by an issuer system. For example, the authorization request may include: (i) an identifier identifying second system 102, (ii) an identifier identifying first system 104, (iii) a requested settlement amount, (iv) a transaction reference identifier generated by second system 102 to uniquely identify the authorization request, (v) one or more remittance fields usable for reconciliation by first system 104 (e.g., an invoice identifier, a purchase order identifier, a claim identifier, a service date, line item details, and/or the like), or any combination thereof.

In some non-limiting embodiments or aspects, second system 102 generates the authorization request, such that the authorization request is independent of issuer-issued payment credentials. For example, the authorization request may omit a PAN, tokenized PAN, CVV, and/or other issuer credential data and may, instead, rely on the identifiers and the transaction reference identifier, described herein. In such embodiments, second system 102 may generate the authorization request as part of an unconventional flow in which authorization is performed system-to-system (e.g., second system 102 to first system 104) prior to TSP processor 106 receiving the settlement request, while settlement of the transaction is later performed over existing settlement infrastructure of the transaction service provider without issuer-issued credentials and without issuer involvement for credential-based authorization.

In some non-limiting embodiments or aspects, second system 102 generates and stores an authorization record corresponding to the generated authorization request. The authorization record may include the transaction reference identifier, the identifier identifying second system 102, the identifier identifying first system 104, the requested settlement amount, the remittance fields, a status indicator (e.g., generated, transmitted, authorized, declined, expired), or any combination thereof. In some non-limiting embodiments or aspects, the authorization record is configured to support correlation of later responses and/or downstream reconciliation information to the authorization request.

In some non-limiting embodiments or aspects, and consistent with a “settlement as a service” configuration, second system 102 may generate the authorization request, such that at least a portion of the authorization request data can be used to create, derive, and/or populate one or more clearing-oriented data structures for downstream processing. For example, second system 102 may generate the authorization request to include, as remittance fields, sufficient transaction descriptors to enable subsequent generation of a “records file” and/or a “batch file” (e.g., a set of transaction records) for clearing and settlement processing over existing payment network rails via an endpoint connection, as described herein.

In some non-limiting embodiments or aspects, second system 102 performs one or more formatting and/or validation operations prior to transmitting the authorization request to improve downstream processing reliability. For example, second system 102 may perform a “format edit” on the authorization request by validating that required fields are present, that field values satisfy formatting rules, and/or that the requested settlement amount satisfies one or more thresholds and may store an exception indicator in the authorization record when a format edit fails. In such embodiments, second system 102 may inhibit or prevent transmission of authorization requests that are not format-valid, thereby reducing downstream rejects in a credential-less flow that later leverages the settlement infrastructure of the transaction service provider.

In some non-limiting embodiments or aspects, second system 102 generates the authorization request with one or more technical controls configured to reduce replay, tampering, and/or misrouting in the credential-less environment. For example, second system 102 may generate the authorization request to include one or more of: (i) a timestamp, (ii) an expiration time, (iii) a nonce or sequence number, (iv) an idempotency key, (v) a message authentication code (MAC) or digital signature computed over at least a portion of the authorization request, or any combination thereof. In such embodiments, first system 104 may later validate the timestamp/expiration, nonce/sequence number, and/or MAC/digital signature prior to authorizing the pre-authorized transaction, thereby enabling credential-less pre-authorization without reliance on issuer credential issuance or issuer-based authorization infrastructure.

In some non-limiting embodiments or aspects, second system 102 generates the authorization request to include routing information indicating an intended recipient (e.g., first system 104) and/or an intended communication path (e.g., via claim system 105). For example, second system 102 may include, in the authorization request, an endpoint identifier (e.g., an endpoint address and/or endpoint token) usable to route the authorization request through claim system 105 and/or to first system 104, where the endpoint identifier is associated with a secure link between systems. In such embodiments, the endpoint identifier may also be used to route subsequent reports (e.g., settlement reports) and/or confirmation messages to second system 102 and/or to a system that hosts second system 102, thereby supporting end-to-end reconciliation in the credential-less flow, described herein.

In some non-limiting embodiments or aspects, process 200 may further include (before TSP processor 106 receives the settlement request): transmitting, with second system 102, the authorization request to first system 104. For exampleand referring also to reference number 504 of FIG. 5, after generating the authorization request, second system 102 may transmit the authorization request to first system 104. For example, second system 102 may generate the authorization request and transmit the authorization request to first system 104, optionally via claim system 105.

In some non-limiting embodiments or aspects, second system 102 transmits the authorization request via one or more communication interfaces over one or more networks. In some implementations, second system 102 may transmit the authorization request directly to first system 104. In some implementations, system 100 may include claim system 105 configured to facilitate communications between second system 102 and first system 104, such as authorization requests and/or authorization responses therebetween, and second system 102 may transmit the authorization request to first system 104 via claim system 105.

In some non-limiting embodiments or aspects, second system 102 transmits the authorization request using a secure link between second system 102 and first system 104 (directly and/or via claim system 105). For example, second system 102 may establish a secure session with first system 104 and/or claim system 105 using transport layer security (TLS) and may transmit the authorization request within the secure session. In some non-limiting embodiments or aspects, second system 102 encrypts at least a portion of the authorization request prior to transmission, and first system 104 decrypts the encrypted portion upon receipt. In some non-limiting embodiments or aspects, second system 102 transmits the authorization request together with message-type metadata indicating that the message corresponds to an authorization request for a credential-less transaction, thereby enabling first system 104 to process the authorization request using an authorization workflow distinct from issuer-based authorization message processing.

In some non-limiting embodiments or aspects, second system 102 transmits the authorization request with one or more reliability controls configured to support fault-tolerant delivery and reduce duplicative authorization processing. For example, second system 102 may include, in the authorization request, an idempotency key and/or a transaction reference identifier, and may store, in association with an authorization record, a transmission status. In such embodiments, if second system 102 does not receive a response within a threshold time period and retransmits the authorization request, first system 104 may detect the idempotency key and/or transaction reference identifier and suppress duplicate authorization processing associated with repeated transmissions.

In some non-limiting embodiments or aspects, claim system 105 (if used) receives the authorization request from second system 102 and performs one or more routing operations to transmit the authorization request to first system 104. In some non-limiting embodiments or aspects, claim system 105 performs one or more validation operations prior to routing the authorization request. For example, claim system 105 may perform a format edit on the authorization request by validating that required fields are present and satisfy formatting rules and may reject, flag, and/or request correction of authorization requests that fail the format edit, thereby improving downstream processing reliability. As further described herein, such improved upstream data quality supports the unconventional credential-less flow in which settlement is later performed over existing transaction service provider settlement rails without issuer-provided credentials.

In some non-limiting embodiments or aspects, second system 102 receives a response message corresponding to receipt of the authorization request (e.g., from claim system 105 and/or first system 104). The response message may indicate that the authorization request has been received and queued for processing and may include a correlation value corresponding to the transaction reference identifier. In some non-limiting embodiments or aspects, second system 102 updates an authorization record based on the response message (e.g., setting a status indicator from transmitted to acknowledged), thereby enabling traceable, idempotent operation in the event of network timeouts or retries.

In some non-limiting embodiments or aspects, second system 102 transmits the authorization request, such that first system 104 can authorize the pre-authorized transaction prior to first system 104 generating the settlement request and prior to TSP processor 106 receiving the settlement request. In such embodiments, the authorization request transmission supports an unconventional credential-less flow in which authorization is performed system-to-system (e.g., second system 102 to first system 104) without issuer-issued credentials, while settlement of the transaction is later performed over existing settlement infrastructure of the transaction service provider (e.g., using settlement infrastructure also used for credential-based electronic payment transactions) without issuer involvement for credential issuance or credential-based authorization.

In some non-limiting embodiments or aspects, process 200 may further include (before TSP processor 106 receives the settlement request): in response to receiving the authorization request, authorizing, with first system 104, the pre-authorized transaction. For example and referring also to reference number 506 of FIG. 5, in response to receiving the authorization request transmitted by second system 102, first system 104 may authorize the pre-authorized transaction. In some implementations, first system 104 may receive the authorization request directly from second system 102. In some implementations, first system 104 may receive the authorization request via claim system 105, which facilitates communications between second system 102 and first system 104, including authorization requests and/or authorization responses.

In some non-limiting embodiments or aspects, first system 104 performs one or more message processing and validation operations on the authorization request prior to authorizing the pre-authorized transaction. For example, first system 104 may parse the authorization request to extract an identifier of second system 102, an identifier of first system 104, a requested settlement amount, a transaction reference identifier, one or more remittance fields, or any combination thereof. In some non-limiting embodiments or aspects, first system 104 validates that the identifier of first system 104 corresponds to first system 104, thereby confirming that the authorization request is intended for first system 104. In some non-limiting embodiments or aspects, first system 104 validates that the identifier of second system 102 corresponds to second system 102, thereby confirming that the authorization request comes from a known entity or B2B partner. In some non-limiting embodiments or aspects, first system 104 validates that the authorization request is independent of issuer-issued payment credentials (e.g., omits a PAN, tokenized PAN, CVV, and/or similar issuer credential data) and, instead, relies on the system identifiers and other fields, described herein, consistent with a credential-less flow.

In some non-limiting embodiments or aspects, first system 104 validates one or more technical controls included in the authorization request to reduce replay, tampering, and/or misrouting. For example, first system 104 may validate a timestamp and/or expiration time and reject the authorization request when the authorization request is stale or expired. Additionally, or alternatively, first system 104 may validate a nonce and/or sequence number to detect and reject replayed authorization requests. Additionally or alternatively, first system 104 may verify a MAC and/or digital signature computed over at least a portion of the authorization request to confirm integrity of the authorization request data. Additionally, or alternatively, first system 104 may validate an idempotency key and/or transaction reference identifier to detect duplicate transmissions and suppress duplicative authorization processing (e.g., where second system 102 retransmits the authorization request due to a timeout). In such embodiments, first system 104 may store an authorization state associated with the idempotency key and/or transaction reference identifier to support idempotent processing.

In some non-limiting embodiments or aspects, first system 104 performs one or more formatting and/or field validation operations prior to applying authorization rules. For example, first system 104 may perform a format edit by validating that required fields are present, that one or more fields satisfy formatting rules, and/or that remittance fields satisfy one or more reconciliation readiness criteria. In such embodiments, first system 104 may reject or flag authorization requests that fail a format edit, thereby reducing downstream exceptions and improving end-to-end processing reliability in the credential-less flow.

In some non-limiting embodiments or aspects, first system 104 authorizes the pre-authorized transaction based on one or more authorization rules and/or policy checks. For example, first system 104 may evaluate the requested settlement amount against thresholds, limits, and/or permitted transaction criteria associated with second system 102 and/or the identifier of second system 102. Additionally, or alternatively, first system 104 may evaluate whether remittance fields, included in the authorization request, satisfy one or more reconciliation criteria (e.g., presence of invoice identifiers, purchase order identifiers, claim identifiers, service dates, line item details, and/or the like). Additionally or alternatively, first system 104 may perform one or more risk checks based on historical transaction data stored by first system 104 for second system 102 (e.g., historical settlement amounts, frequency of authorization requests, anomalies relative to prior requests, etc.). In some non-limiting embodiments or aspects, first system 104 performs the authorization rules and/or policy checks without interacting with an issuer system for credential-based authorization.

In some non-limiting embodiments or aspects, in response to successful validation and evaluation, first system 104 authorizes the pre-authorized transaction by generating an authorization decision indicating approval. In some non-limiting embodiments or aspects, first system 104 stores an authorization record including at least the transaction reference identifier, the identifier of second system 102, the requested settlement amount (and/or an authorized amount), a status indicator indicating authorized, and optionally one or more remittance fields retained for later reconciliation, and/or reporting. In some non-limiting embodiments or aspects, first system 104 authorizes the pre-authorized transaction subject to one or more authorization constraints, such as an expiration time after which the authorization is no longer valid for generating a settlement request.

In some non-limiting embodiments or aspects and referring also to reference number 508 of FIG. 5, first system 104 generates and transmits an authorization response indicating the authorization decision. In some non-limiting embodiments or aspects, the authorization response includes the transaction reference identifier and an authorization status (e.g., authorized or declined). In some non-limiting embodiments or aspects, where the authorization request is declined, the authorization response includes one or more decline indicators usable by second system 102 for exception handling. In some non-limiting embodiments or aspects, first system 104 transmits the authorization response to second system 102 directly and/or via claim system 105.

In some non-limiting embodiments or aspects, and to support subsequent settlement and reconciliation, first system 104 stores, in association with the authorization record, one or more values usable to machine-validate a subsequently generated settlement request as corresponding to an authorized pre-authorized transaction. For example, first system 104 may store the transaction reference identifier, an authorized amount (which may be equal to or different from the requested settlement amount), an authorization status indicator, and/or an authorization expiration time. In such embodiments, first system 104 may be configured to generate the settlement request only when the authorization status indicator indicates authorized and the authorization has not expired, thereby binding the settlement request to a prior authorization event. In this way, non-limiting embodiments or aspects of systems and methods, described herein, may provide a secure binding between pre-authorization and settlement execution in the credential-less flow. For example, first system 104 may store, in association with an authorization record corresponding to an authorized authorization request, a transaction reference identifier, an authorized amount, and/or an authorization expiration time and may generate the settlement request (and transmit the settlement request to TSP processor 106) only when the authorization status indicates authorized and the authorization expiration time has not expired. First system 104 and/or TSP processor 106 may bind the settlement request to the prior authorization event by including, in the settlement request, the transaction reference identifier and the authorized amount, and by generating and/or verifying a MAC or digital signature over at least the transaction reference identifier, the first identifier, the second identifier, and the settlement amount, together with a timestamp and/or nonce. In such embodiments, TSP processor 106 may validate that the settlement request corresponds to a previously authorized pre-authorized transaction (e.g., by validating the MAC/signature, freshness, and correlation to stored authorization state) and reject settlement requests that are stale, replayed, modified, or not linked to an authorized authorization request, thereby reducing unauthorized settlement injection and improving integrity of networked settlement execution over settlement system 108 without relying on issuer-provided credentials, thereby enforcing technical controls over execution of networked settlement operations in the unconventional credential-less flow.

In some non-limiting embodiments or aspects, the authorization performed by first system 104 is part of an unconventional credential-less flow in which authorization is performed system-to-system (e.g., second system 102 to first system 104) without issuer-issued credentials, and thereafter settlement is performed over existing settlement infrastructure of the transaction service provider (e.g., via TSP processor 106 and settlement system 108) without issuer involvement for credential issuance or credential-based authorization. In such embodiments, the authorization record and remittance fields may further support downstream reconciliation and/or reporting (e.g., correlation of settlement confirmations and/or settlement reports to the pre-authorized transaction using the transaction reference identifier).

In some non-limiting embodiments or aspects, process 200 may further include (before TSP processor 106 receives the settlement request): in response to authorizing the authorization request, generating, with first system 104, the settlement request. For example and referring also to reference number 510 of FIG. 5, in response to authorizing the authorization request, first system 104 may generate the settlement request and, referring also to reference number 512 of FIG. 5, transmit the settlement request to TSP processor 106. In some non-limiting embodiments or aspects, first system 104 generates the settlement request after successfully validating and authorizing the authorization request and prior to TSP processor 106 receiving the settlement request. First system 104 may then transmit the settlement request to TSP processor 106. In some implementations, first system 104 may transmit the settlement request to TSP processor 106 directly. In some implementations, first system 104 may transmit the settlement request to TSP processor 106 via claim system 105 (e.g., claim system 105 may route the settlement request to TSP processor 106).

In some non-limiting embodiments or aspects, first system 104 generates the settlement request by assembling a structured electronic message (e.g., a message data structure stored in memory) using values stored in an authorization record corresponding to the authorized pre-authorized transaction. For example, first system 104 may retrieve, from storage, a transaction reference identifier, an authorized amount (or settlement amount), one or more remittance fields retained from the authorization request, or any combination thereof, and may populate corresponding fields of the settlement request. In some non-limiting embodiments or aspects, first system 104 generates the settlement request only when an authorization status indicator indicates authorized and an authorization expiration time (if used) has not expired, thereby binding the settlement request to a prior authorization event.

In some non-limiting embodiments or aspects, the settlement request may contain the first identifier, the second identifier, and the settlement amount. The first identifier may be a unique identifier identifying first system 104 from a plurality of systems, and the second identifier may be a unique identifier identifying second system 102 from a plurality of systems. The first and second identifiers may not be or include bank BINs, PANs, or the like issued by transaction service providers to issuers. Instead, the unique identifiers may identify the payor/payee involved in the credential-less transaction.

In some non-limiting embodiments or aspects, first system 104 generates the settlement request, such that the settlement request is independent of issuer-issued payment credentials. For example, the settlement request may omit a PAN, tokenized PAN, CVV, and/or other issuer credential data and may, instead, include the first identifier and the second identifier, as described herein. In such embodiments, first system 104 may generate and transmit the settlement request as part of an unconventional flow in which (i) authorization is performed system-to-system (e.g., second system 102 to first system 104) without issuer-issued credentials and (ii) settlement is later performed over existing settlement infrastructure of the transaction service provider (e.g., via TSP processor 106 and settlement system 108) without issuer involvement for credential issuance or credential-based authorization.

In some non-limiting embodiments or aspects, first system 104 generates the settlement request to include one or more correlation fields that enable downstream validation, reconciliation, and reporting. For example, the settlement request may include a transaction reference identifier that corresponds to (or is derived from) the transaction reference identifier included in the authorization request, thereby enabling TSP processor 106 and/or claim system 105 to correlate settlement processing results to a pre-authorization event. Additionally or alternatively, the settlement request may include one or more remittance fields (e.g., an invoice identifier, a purchase order identifier, a claim identifier, a service date, line item details, and/or the like) usable for reconciliation and/or inclusion in settlement reports.

In some non-limiting embodiments or aspects, first system 104 generates the settlement request to include one or more technical controls configured to improve integrity and replay resistance for settlement processing. For example, first system 104 may include a timestamp, an expiration time for the settlement request, a nonce or sequence number, an idempotency key for safe retries, and/or a MAC or digital signature computed over at least a portion of the settlement request (e.g., computed over the first identifier, the second identifier, the settlement amount, and the transaction reference identifier). In such embodiments, the technical controls may enable receiving systems (e.g., claim system 105 and/or TSP processor 106) to detect stale, replayed, or modified settlement requests without reliance on issuer credential-based security mechanisms.

In some non-limiting embodiments or aspects, and consistent with a settlement-as-a-service configuration, first system 104 may generate the settlement request, such that the settlement request and/or information derived, therefrom, can be used to generate, derive, and/or populate a records file and/or a batch file for downstream clearing and settlement processing over existing payment network rails via an endpoint connection. For example, first system 104 and/or claim system 105 may use information in the settlement request to generate a set of transaction records (e.g., debit/credit records) in a batch format for submission to a payment network environment via a payment endpoint, while maintaining correlation to the settlement request using the transaction reference identifier.

In some non-limiting embodiments or aspects, first system 104 performs one or more formatting and/or validation operations prior to transmitting the settlement request. For example, first system 104 and/or claim system 105 may perform a format edit to validate that required settlement request fields are present and satisfy formatting rules prior to forwarding the settlement request (or records derived therefrom) for clearing and settlement processing, thereby reducing downstream exceptions and improving traceability and reliability in the credential-less flow.

In some non-limiting embodiments or aspects, the use of the first identifier and the second identifier as unique payor/payee identifiers (rather than BINs, PANs, or other issuer credential-related identifiers) enables TSP processor 106 to perform routing and account resolution for settlement processing without issuer-provided credentials. For example, during an onboarding and/or registration process, first system 104 and second system 102 may be associated, at TSP processor 106 (and/or within a directory service accessible to TSP processor 106), with one or more settlement parameters, such as an associated account at a corresponding bank (e.g., bank 110 and/or bank 114), a settlement routing profile, and/or an endpoint identifier usable to deliver settlement status and/or settlement reports. In such embodiments, when the settlement request includes the first identifier and the second identifier, TSP processor 106 can use the identifiers to locate the corresponding settlement parameters (e.g., map the first identifier to the account of first system 104 at bank 110 and map the second identifier to the account of second system 102 at bank 114), thereby enabling settlement of the credential-less transaction over existing transaction service provider settlement infrastructure without issuer involvement for credential issuance or credential-based authorization.

Referring again to step 202 of process 200, as shown in FIG. 2, in some implementations, TSP processor 106 may receive the settlement request directly from first system 104. In some implementations, TSP processor 106 may receive the settlement request via claim system 105 (e.g., claim system 105 routes the settlement request from first system 104 to TSP processor 106).

The settlement request received by TSP processor 106 may be associated with the pre-authorized transaction between first system 104 and second system 102, the pre-authorized transaction being associated with a settlement amount to be transferred from an account of first system 104 to an account of second system 102. In some non-limiting embodiments or aspects, the pre-authorized transaction is initiated by second system 102 without a credential issued to second system 102 by an issuer system, and the pre-authorized transaction is authorized by first system 104 prior to TSP processor 106 receiving the settlement request, thereby enabling an unconventional credential-less flow in which settlement is performed over existing transaction service provider settlement rails without issuer-provided credentials.

In some non-limiting embodiments or aspects, TSP processor 106 receives the settlement request via an endpoint connection and/or secure link. For example, TSP processor 106 may expose one or more endpoint addresses and/or endpoint identifiers for receiving settlement requests, and first system 104 (and/or claim system 105) may transmit the settlement request to the endpoint address associated with TSP processor 106. In some non-limiting embodiments or aspects, TSP processor 106 authenticates the source of the settlement request based on the endpoint connection (e.g., a provisioned endpoint token, mutual authentication, and/or a secure session), thereby enabling credential-less settlement processing without reliance on issuer-issued payment credentials.

In some non-limiting embodiments or aspects, upon receipt of the settlement request, TSP processor 106 performs one or more intake operations to support reliable, traceable processing. For example, TSP processor 106 may generate and store a receipt record including a receive time, a message identifier, a correlation value (e.g., a transaction reference identifier), and/or a processing status (e.g., received, validated, queued, rejected). In some non-limiting embodiments or aspects, TSP processor 106 transmits a response message indicating receipt of the settlement request (e.g., indicating received and queued), and the response message may include the correlation value for end-to-end traceability. For example, these correlation fields and records may provide an end-to-end traceability control plane for credential-less settlement execution over existing payment network rails. As an example, TSP processor 106 may correlate an authorization request, an authorization response, a settlement request, a routing determination record, one or more downstream transaction records (e.g., within a records file and/or batch file), and/or one or more settlement outputs (e.g., settlement confirmations and/or settlement reports) using a transaction reference identifier and/or remittance fields. In such embodiments, TSP processor 106 may store a receipt record (e.g., including a receive time, a message identifier, a correlation value, and/or a processing status) and an execution state record correlated to the transaction reference identifier and may store the routing determination record correlated to the transaction reference identifier, thereby enabling automated monitoring of processing state transitions, isolation of failure points (e.g., format edit failures, corridor constraint failures, or execution window failures), and generation of actionable exception indicators for remediation. This control-plane traceability improves reliability and diagnosability of distributed network execution in settlement system 108 (including across retries and settlement windows) and supports TSP processor 106 controlling and monitoring of execution of networked settlement operations in the unconventional credential-less flow.

In some non-limiting embodiments or aspects, TSP processor 106 performs one or more validation operations on the settlement request prior to further settlement processing. For example, TSP processor 106 may perform a format edit to validate that required fields are present and satisfy formatting rules, and may reject, flag, and/or request correction of settlement requests that fail the format edit. In some non-limiting embodiments or aspects, TSP processor 106 validates one or more technical controls included in the settlement request, such as a timestamp and/or expiration time, a nonce or sequence number, an idempotency key, and/or a MAC or digital signature, thereby enabling detection of stale, replayed, duplicated, or modified settlement requests without relying on issuer credential-based security mechanisms. These format edit and validation operations may provide a technical data-quality gate that reduces downstream settlement exceptions and improves network resource utilization in existing payment network rails processing. For example, by inhibiting or preventing transmission and/or routing of authorization requests or settlement requests that are not format-valid (e.g., missing required fields, containing improperly formatted identifiers, containing invalid currency designations, or failing threshold and/or reconciliation readiness criteria), second system 102, claim system 105, first system 104, and/or TSP processor 106 may reduce the number of malformed transaction records that would otherwise enter downstream clearing and settlement processing in settlement system 108. In such embodiments, the data-quality gate reduces message rejection events, exception-queue growth, and retransmission traffic within the networked settlement infrastructure, and improves end-to-end processing reliability for unconventional credential-less flows that settle over existing payment network rails without issuer-provided credentials.

In some non-limiting embodiments or aspects, TSP processor 106 performs one or more idempotency operations to suppress duplicate settlement processing. For example, TSP processor 106 may determine whether a settlement request having a same idempotency key and/or transaction reference identifier has previously been received, and when duplication is detected, TSP processor 106 may suppress creation of a duplicate settlement instruction while optionally returning a response message indicating a prior processing status associated with the settlement request. In this way, the idempotency controls and execution-state tracking, described herein, provide an effectively-once settlement execution mechanism for networked settlement operations. For example, upon receipt of a settlement request, TSP processor 106 may generate and store a receipt record and associate the settlement request with an idempotency key and/or transaction reference identifier and may transition an execution state record through a plurality of states (e.g., received, validated, queued, scheduled, submitted, settled, failed, reversed). In such embodiments, when duplicate settlement requests are received (e.g., due to timeouts, retries, or duplicate transmissions over the endpoint connection), TSP processor 106 may detect the duplicate based on the idempotency key and/or transaction reference identifier and suppress creation of a duplicate settlement instruction and/or suppress duplicate submission of settlement instructions into settlement system 108, while optionally returning a response message indicating a prior processing status. By enforcing this idempotent, state-driven processing across intake and execution, the systems and methods, described herein, reduce duplicate postings, reversals, and exception handling traffic in settlement system 108 and improve reliability of distributed network execution.

In some non-limiting embodiments or aspects, and consistent with a settlement-as-a-service configuration, TSP processor 106 may convert the settlement request and/or information derived, therefrom, into one or more downstream processing data structures. For example, TSP processor 106 (alone and/or in cooperation with claim system 105) may create, derive, and/or populate a records file and/or a batch file comprising one or more transaction records corresponding to settlement requests received during a time window and may route the records file and/or batch file for clearing and settlement processing using settlement system 108. In some non-limiting embodiments or aspects, TSP processor 106 maintains correlation between each settlement request and corresponding downstream transaction records using the transaction reference identifier and/or remittance fields, thereby enabling later production and routing of settlement confirmations and/or settlement reports.

In some non-limiting embodiments or aspects, TSP processor 106 provides an interoperability layer that transforms credential-less settlement requests into standardized, rails-native transaction records for processing by settlement system 108. For example, upon receiving a settlement request that includes the first identifier, the second identifier, the settlement amount, and correlation fields (e.g., a transaction reference identifier and/or remittance fields), TSP processor 106 may map the identifiers to settlement parameters and generate one or more network-compatible transaction records (e.g., debit and credit records) that conform to a message format designation and corridor constraints associated with settlement system 108. TSP processor 106 may aggregate the transaction records into a records file and/or batch file for submission via a payment endpoint and/or endpoint connection into settlement system 108, while maintaining correlation between the rails-native records and the original settlement request using the transaction reference identifier and/or remittance fields. In such embodiments, settlement system 108 can execute clearing and settlement using existing payment network rails and standardized processing operations, while the systems and methods, described herein, enable credential-less settlement initiation and authorization without issuer-issued credentials. This interoperability transformation improves integration reliability and reduces implementation complexity by allowing credential-less transactions to be settled using existing rails processing paths, rather than requiring bespoke bank-instruction workflows or modifications to issuer credential infrastructure.

Accordingly, the receipt and validation operations performed by TSP processor 106 support the unconventional credential-less flow, described herein, by enabling settlement processing to proceed over existing transaction service provider settlement infrastructure using the first identifier and the second identifier (rather than issuer-provided credentials), while preserving traceability and reliability suitable for high-volume automated settlement processing. For example, TSP processor 106 may perform format edits and field validation, validate technical controls (e.g., timestamps/expirations, nonces/sequence numbers, and/or MACs/digital signatures), and apply idempotency controls to suppress duplicate processing. TSP processor 106 may convert settlement requests into rails-native transaction records (e.g., debit and credit records) and aggregate such records into records files and/or batch files for submission via a payment endpoint and/or endpoint connection for clearing and settlement using settlement system 108, while maintaining correlation to the settlement request using a transaction reference identifier and/or remittance fields. In such embodiments, the combination of (i) validated intake controls and (ii) standardized transformation and submission into the existing payment network rails reduces downstream exceptions and retransmissions and improves end-to-end traceability of networked settlement execution in the credential-less flow.

As shown in FIG. 2, at step 204, process 200 may include: in response to receiving the settlement request, identifying, with the transaction service provider processor, the account of the first system and the account of the second system based on a first identifier and a second identifier contained in the settlement request. For example and referring also to reference number 514 of FIG. 5, in response to receiving the settlement request, TSP processor 106 may identify the account of first system 104 and the account of second system 102 based on the first identifier and the second identifier contained in the settlement request. In such embodiments, TSP processor 106 may perform account identification without relying on issuer-issued payment credentials and without using BINs, PANs, or the like issued by transaction service providers to issuers, consistent with the credential-less flow, described herein.

In some non-limiting embodiments or aspects, TSP processor 106 identifies the account of first system 104 by performing a lookup using the first identifier in a directory service and/or mapping data structure accessible to TSP processor 106. In some non-limiting embodiments or aspects, TSP processor 106 identifies the account of second system 102 by performing a lookup using the second identifier in the directory service and/or mapping data structure. In some non-limiting embodiments or aspects, the directory service and/or mapping data structure stores associations between (i) unique identifiers of participating systems (e.g., the first identifier and the second identifier) and (ii) settlement parameters for those systems, such as an associated bank account identifier, bank routing data, a settlement routing profile, a settlement currency profile, and/or one or more endpoint identifiers usable to deliver settlement status, settlement confirmations, and/or settlement reports.

In some non-limiting embodiments or aspects, the associations in the directory service and/or mapping data structure are established during onboarding and/or registration of systems (e.g., first system 104, second system 102, etc.) with TSP processor 106. For example, first system 104 and second system 102 may register their respective settlement parameters and may be assigned and/or verified with unique identifiers (e.g., the first identifier and the second identifier) usable in the credential-less flow, described herein. In some non-limiting embodiments or aspects, TSP processor 106 stores, updates, and/or verifies such settlement parameters using one or more verification operations (e.g., account verification, endpoint verification, and/or profile validation) prior to enabling settlement processing for the system.

In some non-limiting embodiments or aspects, TSP processor 106 performs one or more validation operations prior to or during account identification. For example, TSP processor 106 may validate that the first identifier and the second identifier correspond to active, onboarded participants; validate that the participants are permitted to transact with each other; validate that settlement processing is enabled for the participant profiles; validate that a requested currency and/or settlement amount satisfies profile constraints; and/or validate that a settlement request includes required correlation fields (e.g., a transaction reference identifier, etc.) usable for traceability.

In some non-limiting embodiments or aspects, TSP processor 106 performs one or more routing determinations based on the identified settlement parameters. For example, when the mapping data indicates that first system 104 and second system 102 are associated with different banks (e.g., bank 110 and bank 114), TSP processor 106 may determine an interbank settlement routing path using settlement system 108. Additionally or alternatively, when the mapping data indicates that first system 104 and second system 102 are associated with different countries and/or different currencies, TSP processor 106 may determine a cross-border settlement routing path and/or perform a currency handling operation, according to a settlement currency profile.

In some implementations, TSP processor 106 may determine one or more routing determinations based on the identified settlement parameters by executing a routing determination process that selects, from a plurality of available settlement corridors supported by settlement system 108, a routing path and one or more routing directives for execution of networked settlement operations. In some non-limiting embodiments or aspects, TSP processor 106 stores and/or accesses one or more routing tables, corridor matrices, and/or graph-based representations in which nodes correspond to participating settlement institutions and/or settlement endpoints and edges correspond to supported settlement corridors and associated operational constraints, including supported currencies, settlement windows, cut-off times, message formats, and corridor limits.

After mapping the first identifier and the second identifier to settlement parameters for first system 104 and second system 102, respectively, TSP processor 106 may determine a corridor attribute set for the settlement request including: (i) the identified bank associated with the account of first system 104 (e.g., bank 110), (ii) the identified bank associated with the account of second system 102 (e.g., bank 114), (iii) a settlement currency designation and/or geography designation associated with each account, and/or (iv) the settlement amount. TSP processor 106 may then query the routing tables, corridor matrices, and/or graph representation to enumerate candidate routes through settlement system 108, including at least one of a direct corridor between bank 110 and bank 114 or an indirect corridor via an intermediate settlement participant, and/or filter the candidate routes by applying feasibility constraints derived from one or more settlement routing profiles and/or a settlement currency profile. For example, TSP processor 106 may exclude candidate routes that do not support the settlement currency, that are outside an operational settlement window or after a cut-off time, that violate corridor limits, or that are disallowed by counterparty or geography constraints.

For each feasible candidate route, TSP processor 106 may compute one or more route scores based on technical execution attributes including at least one of: an estimated settlement time, an expected failure probability based on corridor health metrics, a number of network hops or legs, an estimated processing load, and/or a cost attribute. In such embodiments, TSP processor 106 may select a routing path based on the computed route scores (e.g., selecting a lowest-score path or selecting a path satisfying a priority ordering), and generate routing directives that control execution of the settlement over settlement system 108, including at least one of: a selected corridor identifier, a settlement window designation, a message format designation, one or more intermediate steps when applicable, or any combination thereof.

The routing determination process performed by TSP processor 106 may provide resiliency and automatic failover for networked settlement execution over settlement system 108. For example, when a plurality of feasible settlement corridors is available for a given corridor attribute set, TSP processor 106 may select a primary corridor based on route scores and corridor health metrics and may further identify one or more alternate corridors as fallback routes. In such embodiments, if a settlement instruction submitted using the primary corridor fails (e.g., due to corridor congestion, elevated latency, corridor unavailability, a cut-off time violation, or a message-format rejection), TSP processor 106 may update the corridor health metrics and re-run the routing determination process to select an alternate corridor and re-generate routing directives for submission within an applicable settlement window, while maintaining correlation to the transaction reference identifier and suppressing duplicate execution using idempotency controls. By dynamically routing around degraded corridors and automatically failing over to alternate corridors, non-limiting embodiments or aspects of systems and methods, described herein, improve availability and reliability of distributed network execution within settlement system 108 and/or reduce repeated failures and retransmissions.

In some non-limiting embodiments or aspects, the routing directives generated by TSP processor 106 include a settlement window designation that is applied as a technical scheduling control for execution of settlement over settlement system 108. For example, based on corridor availability and operational constraints associated with settlement system 108, TSP processor 106 may determine that a settlement request is eligible for execution in a current settlement window, or may defer execution by scheduling submission of corresponding settlement instructions and/or rails-native transaction records for a subsequent settlement window, while maintaining the settlement request in an execution state record (e.g., queued or scheduled). In such embodiments, settlement-window scheduling reduces late submissions, reduces repeated retransmission attempts caused by submitting outside operational windows, and improves predictability and throughput of high-volume settlement processing over existing payment network rails. Further, by storing the settlement window designation and correlating scheduled execution to the transaction reference identifier and the execution state record, TSP processor 106 improves traceability of distributed network execution and enables TSP processor 106 to control timing and sequencing of networked settlement operations in the unconventional credential-less flow.

When the mapping data indicates that first system 104 and second system 102 are associated with different countries and/or different currencies, TSP processor 106 may determine a cross-border settlement routing path by selecting a feasible cross-border corridor and, when currency conversion is to be performed, a currency handling option defined by the settlement currency profile. For example, TSP processor 106 may select a multi-leg routing path including a currency handling leg and an interbank settlement leg and/or may apply rounding and precision rules and/or time-window constraints defined by the settlement currency profile, when generating routing directives.

In some non-limiting embodiments or aspects, TSP processor 106 stores a routing determination record including a selected route identifier, a timestamp, and/or correlation to the transaction reference identifier, thereby enabling traceability of route selection and correlation of subsequent settlement confirmations and/or settlement reports to both (i) the settlement request and (ii) the routing path used to execute settlement.

In this way, the routing determination process provides a technical control over execution of networked transfer operations in settlement system 108. For example, rather than merely instructing a transfer of funds, TSP processor 106 computes and applies routing directives that control corridor selection, message formatting, settlement-window scheduling, and (when applicable) multi-leg routing for cross-border and/or cross-currency settlement, thereby improving operational reliability and reducing downstream exceptions in high-volume settlement processing. These technical controls are particularly advantageous in the unconventional credential-less flow, described herein, because TSP processor 106 performs the routing determinations based on the first identifier and the second identifier and mapped settlement parameters (rather than issuer-provided credentials), while still enabling settlement over existing transaction service provider settlement rails.

In some non-limiting embodiments or aspects, TSP processor 106 identifies the accounts in a manner that supports downstream clearing and settlement processing over existing payment network rails. For example, after mapping the first identifier to the account of first system 104 and mapping the second identifier to the account of second system 102, TSP processor 106 may generate or populate one or more transaction records (e.g., debit and credit records) for inclusion in a records file and/or batch file for downstream processing, while maintaining correlation between the settlement request and the transaction records using the transaction reference identifier and/or remittance fields. Such correlation supports later generation and routing of settlement confirmations and/or settlement reports through an endpoint connection.

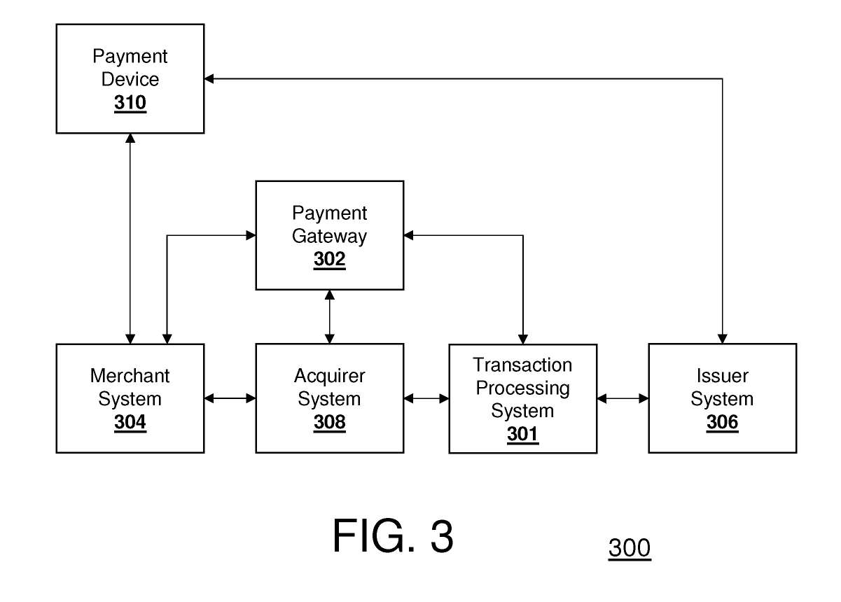

Settlement system 108 and/or the existing payment network rails of electronic payment processing network 300 (FIG. 3) may represent existing clearing and settlement infrastructure of a transaction service provider (e.g., a payment network) configured to route and settle electronic payment transactions among participating financial institutions. Electronic payment processing network 300 may include one or more payment endpoints and network services for receiving transaction records (e.g., records files and/or batch files), performing validation and clearing operations, determining settlement positions, and coordinating settlement between participating banks (e.g., bank 110 and bank 114) associated with respective accounts of the parties. Settlement system 108 may include and/or communicate with one or more network services that generate settlement outputs (e.g., settlement confirmations and/or settlement reports) for delivery to systems participating in the settlement process via an endpoint connection.

Electronic payment processing network 300 may typically be used to settle credential-based electronic payment transactions (e.g., transactions initiated using issuer-issued credentials), and non-limiting embodiments or aspects of systems and methods, described herein, are configured to settle credential-less electronic payment transactions over the same or similar settlement infrastructure. For example, the pre-authorized transaction may be initiated by second system 102 without a credential issued by an issuer system, authorized by first system 104 prior to TSP processor 106 receiving the settlement request and, thereafter, settled over settlement system 108 using transaction service provider settlement infrastructure without issuer involvement for credential issuance or credential-based authorization.

Use of the existing payment network rails of electronic payment processing network 300 provides one or more technical advantages relative to alternative settlement mechanisms. For example, because settlement system 108 and/or payment network rails environment 300 is configured for high-volume transaction processing among participating institutions, non-limiting embodiments or aspects of systems and methods, described herein, can improve scalability and reliability of settlement processing for credential-less transactions. Additionally or alternatively, the payment network rails environment 300 may provide structured validation (e.g., format edits), clearing operations, and settlement position calculations that reduce downstream exceptions and improve traceability of settlement processing. Additionally or alternatively, use of the existing payment network rails of electronic payment processing network 300 may generate settlement outputs (e.g., settlement confirmations and/or settlement reports) that are correlated to pre-authorization and settlement requests (e.g., using transaction reference identifiers and/or remittance fields), thereby improving reconciliation and reporting.

In some non-limiting embodiments or aspects, systems and methods, described herein, further provide an unconventional technical flow that enables settlement over payment network rails without issuer-provided credentials. For example, instead of using issuer-issued payment credentials for authorization and routing, second system 102 and first system 104 perform system-to-system pre-authorization (e.g., via the authorization request and authorization response), and first system 104 transmits a settlement request to TSP processor 106 that includes unique identifiers of the parties (e.g., the first identifier and the second identifier) rather than BIN-based and/or issuer-credential-based identifiers. In such embodiments, TSP processor 106 uses the unique identifiers to identify associated settlement parameters (e.g., accounts at banks 110, 114, routing profiles, and/or endpoint identifiers) and to cause transfer of the settlement amount over settlement system 108, thereby reusing transaction service provider settlement infrastructure, while avoiding issuer credential issuance and issuer-based authorization message processing.

In some non-limiting embodiments or aspects, use of the existing payment network rails of electronic payment processing network 300 can further support settlement between parties associated with different financial institutions and/or different geographies, including cross-border settlement, while maintaining traceability and reconciliation capabilities, described herein. For example, settlement system 108 may coordinate settlement between bank 110 and bank 114 as participating institutions and may provide settlement outputs correlated to the transaction reference identifiers and/or remittance fields stored by one or more of second system 102, first system 104, claim system 105, and/or TSP processor 106.

In some non-limiting embodiments or aspects, the account identification performed by TSP processor 106 is part of an unconventional credential-less flow in which (i) the pre-authorized transaction is initiated by second system 102 without a credential issued by an issuer system and is authorized by first system 104 prior to TSP processor 106 receiving the settlement request and (ii) TSP processor 106 uses the first identifier and the second identifier (rather than issuer-issued credentials) to identify accounts and route settlement over existing transaction service provider settlement infrastructure, thereby enabling settlement without issuer involvement for credential issuance or credential-based authorization.

As shown in FIG. 2, at step 206, process 200 may include causing, with the transaction service provider processor, transfer of the settlement amount from the account of the first system to the account of the second system. For example, after identifying the account of first system 104 and the account of second system 102 based on the first identifier and the second identifier, TSP processor 106 may cause transfer of the settlement amount from the account of first system 104 to the account of second system 102. As an example and referring also to reference numbers 516 and 518 of FIG. 5, TSP processor 106 may cause transfer of the settlement amount by generating one or more settlement instructions and transmitting the settlement instructions for execution via settlement system 108 and one or more bank systems (e.g., first bank system 110 and second bank system 114). In some non-limiting embodiments or aspects, first system 104 may not directly instruct first bank system 110 to transfer the settlement amount from first account 112 to second account 116. Instead, first system 104 transmits the settlement request to TSP processor 106, and TSP processor 106 causes settlement using settlement system 108 and the participating bank systems.

In some non-limiting embodiments or aspects, the settlement request may be processed by TSP processor 106 without interaction with an issuer system. For example, TSP processor 106 may not interact with an issuer system in the course of processing the settlement request. The settlement request may be processed without a credential issued to second system 102 from an issuer system. In such embodiments, TSP processor 106 may cause transfer of funds using the first identifier and the second identifier and associated settlement parameters, rather than issuer-provided credentials and issuer-based authorization messaging.

In some non-limiting embodiments or aspects, TSP processor 106 causes transfer of the settlement amount by applying one or more execution controls prior to transmitting settlement instructions into settlement system 108. For example, TSP processor 106 may validate that the settlement request is in a processable state (e.g., not previously settled), validate an idempotency key and/or transaction reference identifier to suppress duplicate settlement execution, and/or validate that the settlement request is within an execution window (e.g., within a settlement window determined by routing directives). In some non-limiting embodiments or aspects, TSP processor 106 stores an execution state record including a status indicator (e.g., scheduled, submitted, in-process, settled, failed, reversed) correlated to the transaction reference identifier, thereby providing traceability and enabling safe retry and exception handling in the networked settlement process.

In some non-limiting embodiments or aspects, TSP processor 106 causes transfer of the settlement amount by generating settlement instructions in accordance with the routing directives determined by TSP processor 106, as described herein. For example, TSP processor 106 may select, from a plurality of available settlement corridors supported by settlement system 108, a corridor identifier, a message format designation, and a settlement window designation and may generate settlement instructions that conform to the selected corridor and message format and are scheduled for execution within the settlement window. In such embodiments, this routing determination process provides a technical control over execution of networked settlement operations by controlling corridor selection, message formatting, and settlement-window scheduling, thereby reducing settlement rejects due to unsupported corridors, currency incompatibilities, and/or cut-off time violations, and reducing retry traffic and downstream exceptions in high-volume processing.

In some non-limiting embodiments or aspects, and consistent with a settlement-as-a-service configuration, TSP processor 106 causes transfer of the settlement amount by generating and/or populating one or more transaction records (e.g., debit and/or credit records) corresponding to the settlement request and including at least the settlement amount and correlation data (e.g., transaction reference identifier and/or remittance fields). In some non-limiting embodiments or aspects, TSP processor 106 aggregates a plurality of transaction records into a records file and/or batch file for a settlement cycle and submits the records file and/or batch file for clearing and settlement via settlement system 108. In such embodiments, TSP processor 106 may compute and/or obtain settlement positions for one or more participants (e.g., net debit/credit positions for a settlement window) and may cause settlement by transmitting settlement instructions, reflecting such positions to the participating bank systems. In some non-limiting embodiments or aspects, use of settlement system 108, as payment network rails, provides technical advantages including structured validation and clearing operations, high-volume processing capabilities, standardized settlement windows, and generation of settlement outputs (e.g., confirmations and/or settlement reports) correlated to submitted transaction records.

In some non-limiting embodiments or aspects, first bank system 110 may be based in a first country and second bank system 114 may be based in a second country different from the first country (e.g., a cross-border transaction). In a cross-border transaction, the transfer of funds from first account 112 to second account 116 may occur in a first currency and be converted into a second currency before being deposited in second account 116. The second currency may correspond to the currency of second account 116. In such embodiments, TSP processor 106 may cause transfer by selecting and applying a cross-border routing path and currency handling operation (e.g., as specified by a settlement currency profile), and by generating settlement instructions that include currency designation, conversion parameters, and/or settlement timing consistent with the cross-border routing path. In some non-limiting embodiments or aspects, first bank system 110 and second bank system 114 may be based in the same country (e.g., a domestic transaction), and TSP processor 106 may cause transfer using a domestic routing path and currency handling parameters appropriate for the domestic corridor. In such embodiments, selection among available domestic and cross-border corridors and enforcement of corridor constraints (e.g., cut-offs and windows), improves operational reliability and reduces failed or delayed settlement executions.

In some non-limiting embodiments or aspects, the settlement request may be settled using the same settlement infrastructure as credential-based electronic payment transactions. For example, TSP processor 106 may settle credential-based electronic payment transactions after authorization from the issuer system using the same components (e.g., settlement system 108, first bank system 110, and second bank system 114) as TSP processor 106 uses to settle the credential-less pre-authorized transactions in response to receiving the settlement request from first system 104. In such embodiments, non-limiting embodiments or aspects of systems and methods, described herein, provide an unconventional credential-less flow in which authorization is performed system-to-system (without issuer-issued credentials) and settlement is executed over the transaction service provider’s existing payment network rails using the identified accounts and routing directives, without issuer involvement for credential issuance or issuer-based authorization. Further, because settlement system 108 is configured to coordinate settlement among participating institutions, the credential-less flow can leverage standardized network operations (e.g., clearing, settlement windows, and settlement reporting), while avoiding issuer credential issuance and issuer-based authorization message processing.

In some non-limiting embodiments or aspects, TSP processor 106 causes transfer of the settlement amount by transmitting one or more response messages and/or reports indicating execution results. For example, upon submission for settlement and/or upon completion of settlement, TSP processor 106 may generate a settlement confirmation and/or settlement report including the transaction reference identifier and a settlement status (e.g., settled, pending, failed) and transmit the settlement confirmation and/or settlement report to first system 104 and/or second system 102, optionally via claim system 105 and/or an endpoint connection. In such embodiments, the settlement confirmation and/or settlement report may include one or more reconciliation fields (e.g., remittance fields) enabling automated reconciliation and exception management.

In some non-limiting embodiments or aspects, the routing determination process and use of existing payment network rails provide technical advantages to the credential-less settlement flow, for example, by (i) selecting and applying routing directives (corridor selection, message formatting, settlement-window scheduling, and cross-border/cross-currency handling), (ii) generating and submitting standardized transaction records for clearing and settlement over settlement system 108, (iii) applying idempotency and execution-state tracking to suppress duplicates and control retries, and (iv) producing correlated confirmations and/or settlement reports. TSP processor 106 controls execution of distributed network operations within settlement system 108, improves reliability and traceability of settlement execution, and reduces downstream exceptions, while enabling settlement over existing transaction service provider settlement infrastructure without issuer-provided credentials.

In some non-limiting embodiments or aspects, settlement system 108 operates as a settlement agent for settlement processing over payment network rails and maintains, at one or more participating bank systems (e.g., first bank system 110 and/or second bank system 114), and one or more settlement accounts used to effect interbank settlement based on net settlement positions. For example, for a settlement window and/or settlement cycle, TSP processor 106 (and/or settlement system 108) may aggregate a plurality of transaction records (e.g., debit and credit records) into one or more net settlement positions for one or more participating institutions, and settlement system 108 may cause transfer of funds by posting and/or instructing transfers corresponding to the net settlement positions against the settlement account(s) associated with settlement system 108 at the participating bank systems. In such embodiments and referring also to reference numbers 520 and 522 of FIG. 5, the participating bank systems may receive settlement instructions reflecting a net debit or net credit position attributable to a participant (e.g., attributable to first bank system 110 and/or second bank system 114 for the settlement window), and may settle such positions by debiting and/or crediting the settlement account(s) of settlement system 108 and crediting and/or debiting corresponding participant accounts, thereby reducing the number of individual gross transfers executed during the settlement window. The use of net settlement positions posted against settlement system 108 settlement account(s) improves scalability and reliability of high-volume settlement processing over the payment network rails, while maintaining correlation to individual settlement requests via transaction reference identifiers and associated reporting.

FIG. 3 shows an electronic payment processing network 300, according to non-limiting embodiments or aspects. Payment processing network 300 may be used in conjunction with non-limiting embodiments or aspects of systems and methods, described herein. It will be appreciated that the particular arrangement of electronic payment processing network 300 shown is for example purposes only and that various arrangements are possible. Transaction processing system 301 (e.g., a transaction handler) is shown to be in communication with one or more issuer systems (e.g., such as issuer system 306) and one or more acquirer systems (e.g., such as acquirer system 308). Although only a single issuer system 306 and single acquirer system 308 are shown, it will be appreciated that transaction processing system 301 may be in communication with a plurality of issuer systems and/or acquirer systems. In some embodiments, transaction processing system 301 may also operate as an issuer system, such that both transaction processing system 301 and issuer system 306 are a single system and/or controlled by a single entity.

In some non-limiting embodiments or aspects, transaction processing system 301 may communicate with merchant system 304 directly through a public or private network connection. Additionally or alternatively, transaction processing system 301 may communicate with merchant system 304 through payment gateway 302 and/or acquirer system 308. In some non-limiting embodiments or aspects, acquirer system 308 associated with merchant system 304 may operate as payment gateway 302 to facilitate the communication of transaction requests from merchant system 304 to transaction processing system 301. Merchant system 304 may communicate with payment gateway 302 through a public or private network connection. For example, merchant system 304, that includes a physical POS device, may communicate with payment gateway 302 through a public or private network to conduct card-present transactions. As another example, merchant system 304, that includes a server (e.g., a web server), may communicate with payment gateway 302 through a public or private network, such as a public Internet connection, to conduct card-not-present transactions.

In some non-limiting embodiments or aspects, transaction processing system 301, after receiving a transaction request from merchant system 304 that identifies an account identifier of a payor (e.g., such as an account holder) associated with an issued payment device 310 (e.g., a consumer device), may generate an authorization request message to be communicated to issuer system 306 that issued payment device 310 and/or an account identifier. Issuer system 306 may then approve or decline the authorization request and, based on the approval or denial, generate an authorization response message that is communicated to transaction processing system 301. Transaction processing system 301 may communicate an approval or denial to merchant system 304. When issuer system 306 approves the authorization request message, it may then clear and settle the payment transaction between issuer system 306 and acquirer system 308.

It will be appreciated that the system architecture shown in FIG. 3 may be used to process credential-based transactions, while first and second systems 104, 102 of the present disclosure may engage in credential-less transactions using transaction processing system 301 (e.g., TSP processor 106) and without involvement of issuer system 306.

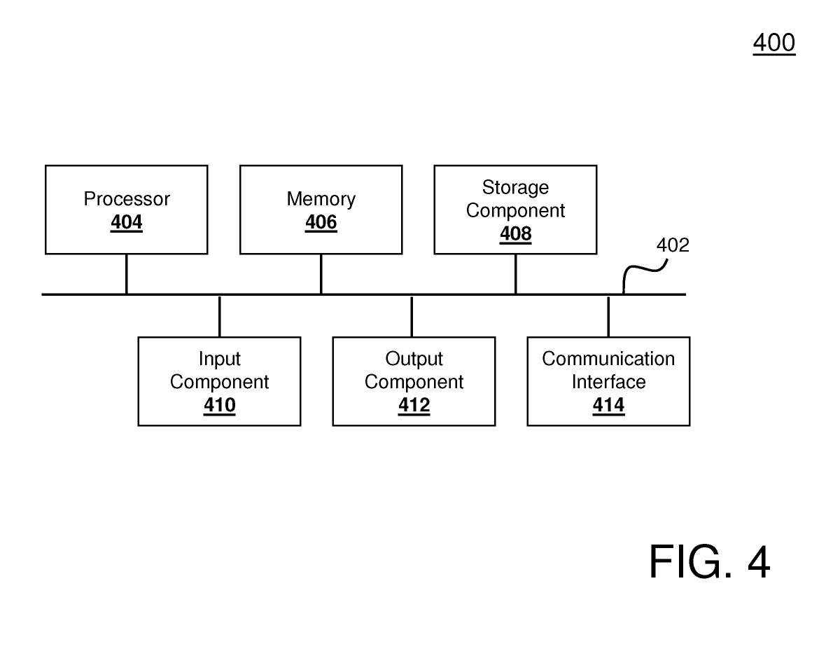

Referring now to FIG. 4, shown is a diagram of example components of device 400, according to non-limiting embodiments. Device 400 may correspond to second system 102, first system 104, claim system 105, TSP processor 106, settlement system 108, first bank system 110, and/or second bank system 114 of FIG. 1, and/or transaction processing system 301, payment gateway 302, merchant system 304, issuer system 306, acquirer system 308, and/or payment device 310 of FIG. 3, as an example. In some non-limiting embodiments, such systems or devices may include at least one device 400 and/or at least one component of device 400. The number and arrangement of components shown are provided as an example. In some non-limiting embodiments, device 400 may include additional components, fewer components, different components, or differently arranged components than those shown. Additionally, or alternatively, a set of components (e.g., one or more components) of device 400 may perform one or more functions described as being performed by another set of components of device 400.

As shown in FIG. 4, device 400 may include bus 402, processor 404, memory 406, storage component 408, input component 410, output component 412, and communication interface 414. Bus 402 may include a component that permits communication among the components of device 400. In some non-limiting embodiments, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid-state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with a transaction service provider processor, a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the transaction service provider processor receiving the settlement request;
in response to receiving the settlement request, identifying, with the transaction service provider processor, the account of the first system and the account of the second system based on a first identifier and a second identifier contained in the settlement request; and
causing, with the transaction service provider processor, transfer of the settlement amount from the account of the first system to the account of the second system.

2. The computer-implemented method of claim 1, further comprising:
generating, with the second system, an authorization request associated with the pre-authorized transaction;
transmitting, with the second system, the authorization request to the first system;
in response to receiving the authorization request, authorizing, with the first system, the pre-authorized transaction; and
in response to authorizing the authorization request, generating, with the first system, the settlement request.

3. The computer-implemented method of claim 1, wherein the settlement request is processed by the transaction service provider processor without interaction with an issuer system.

4. The computer-implemented method of claim 1, wherein the account of the first system is associated with a first bank system, and the account of the second system is associated with a second bank system different from the first bank system.

5. The computer-implemented method of claim 4, wherein the first bank system is based in a first country and the second bank system is based in a second country different from the first country.

6. The computer-implemented method of claim 1, wherein the settlement request contains the first identifier, the second identifier, and the settlement amount.

7. The computer-implemented method of claim 1, wherein the first identifier is a unique identifier identifying the first system, and the second identifier is a unique identifier identifying the second system.

8. The computer-implemented method of claim 1, wherein the settlement request is settled using the same settlement infrastructure as credential-based electronic payment transactions.

9. The computer-implemented method of claim 1, wherein the first system does not directly instruct a first bank system associated with the account of the first system to transfer the settlement amount to the account of the second system.

10. A system, comprising:
at least one processor configured to:
receive a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the at least one processor receiving the settlement request;
in response to receiving the settlement request, identify the account of the first system and the account of the second system based on a first identifier and a second identifier contained in the settlement request; and
cause transfer of the settlement amount from the account of the first system to the account of the second system.

11. The system of claim 10, further comprising:
the first system including one or more first processors; and
the second system including one or more second processors,
wherein the one or more second processors are configured to:
generate an authorization request associated with the pre-authorized transaction; and
transmit the authorization request to the first system,
wherein the one or more first processors are configured to:
in response to receiving the authorization request, authorize the pre-authorized transaction; and
in response to authorizing the authorization request, generate the settlement request.

12. The system of claim 10, wherein the settlement request is processed by the at least one processor without interaction with an issuer system.

13. The system of claim 10, wherein the account of the first system is associated with a first bank system, and the account of the second system is associated with a second bank system different from the first bank system.

14. The system of claim 13, wherein the first bank system is based in a first country and the second bank system is based in a second country different from the first country.

15. The system of claim 10, wherein the settlement request contains the first identifier, the second identifier, and the settlement amount.

16. The system of claim 10, wherein the first identifier is a unique identifier identifying the first system, and the second identifier is a unique identifier identifying the second system.

17. The system of claim 10, wherein the settlement request is settled using the same settlement infrastructure as credential-based electronic payment transactions.

18. The system of claim 10, wherein the first system does not directly instruct a first bank system associated with the account of the first system to transfer the settlement amount to the account of the second system.

19. A computer program product comprising at least one non-transitory computer-readable medium including program instructions that, when executed by at least one processor, cause the at least one processor to:
receive a settlement request associated with a pre-authorized transaction between a first system and a second system, the pre-authorized transaction associated with a settlement amount to be transferred from an account of the first system to an account of the second system, the pre-authorized transaction initiated by the second system without a credential issued to the second system by an issuer system, the pre-authorized transaction authorized by the first system prior to the at least one processor receiving the settlement request;
in response to receiving the settlement request, identify the account of the first system and the account of the second system based on a first identifier and a second identifier contained in the settlement request; and
cause transfer of the settlement amount from the account of the first system to the account of the second system.

20. The computer program product of claim 19, wherein the program instructions, when executed by the at least one processor, cause the at least one processor to process the settlement request without interaction with an issuer system.
